(19) United States
(12) Patent Application Publication
(10) Pub. No.: US 2015/0176812 A1
(43) Pub. Date: Jun. 25, 2015

(54) Solar Path Light

(71) Applicant: Nii Northern International Inc., Markham (CA)

(72) Inventor: Zhou Xinzhou, Cixi (CN)

(21) Appl. No.: 14/576,842

(22) Filed: Dec. 19, 2014

(30) Foreign Application Priority Data
Dec. 20, 2013 (CN) 201320843196.1

(51) Int. Cl. F21V 14/06; F21S 9/03; F21S 10/00

(52) U.S. Cl. CPC F21V 14/06; F21S 10/00; F21S 9/037; F21Y 2101/02

(57) ABSTRACT

This disclosure is generally directed to a solar path light. Existing garden path lights typically generate a fixed, motionless lighting effect. The path light presently disclosed may comprise a photovoltaic cell; an electrochemical cell; a light source; a motor; a rotating portion; a refractive portion; a securing portion; and a covering portion. The path light may further comprise a globe and an extension portion between the globe and the securing portion. The motor may drive the rotating portion, causing the rotating portion and refractive portion to slowly rotate, which may provide a light effect that emulates light reflecting off of a surface of a body of water.

### FIELD

The present disclosure relates generally to solar path lights.

### BACKGROUND

Existing garden path lights typically generate a fixed, motionless lighting effect.

### SUMMARY

The present disclosure relates generally to a solar path light comprising a refracting portion that may slowly revolve around a rotating portion, which may provide a light effect that emulates light reflecting off of a surface of a body of water.

A path light may comprise: a photovoltaic cell comprising a light-receiving face; an electrochemical cell electrically connected to the photovoltaic cell, and configured to receive electrical energy from the photovoltaic cell; a light source electrically connected to the electrochemical cell, and configured to receive electrical energy from the electrochemical cell; a motor electrically connected to the electrochemical cell, and configured to receive electrical energy from the electrochemical cell; a rotating portion extending downwardly from the motor and in mechanical communication with the motor, and configured to rotate when the motor receives electrical energy; a refractive portion in mechanical communication with the rotating portion, and configured to rotate in response to rotation of the rotating portion; a securing portion configured to secure the path light to a bottom surface; and a covering portion above the light source, wherein the covering portion is configured to prevent at least a portion of light emitted from the light source from emanating upwardly.

Optionally, the path light may further comprise a globe at least partially surrounding the refractive portion. Optionally, the covering portion may comprise an eave that extends laterally from the globe. Optionally, the globe may be translucent. Optionally, the path light may further comprise an extension portion in mechanical communication with the securing portion and the globe such that the globe is positioned above the securing portion. Optionally, the path light may further comprise a reflecting portion. Optionally, the light-receiving face of the photovoltaic cell may be positioned to face upwardly from the covering portion. Optionally, the path light may further comprise a globe tray, which may be located between the globe and the extension portion. Optionally, the globe may comprise an external lampshade. Optionally, the globe may be substantially spherical or substantially pear-shaped. Optionally, the refracting portion may be bowl-shaped. Optionally, the motor may be a DC motor. Optionally, the rotating portion may be configured to rotate at 0.5 to 60 revolutions per minute (e.g., at 1 revolution per minute). Optionally, the path light may further comprise a user-actuatable switch. Optionally, the user-actuatable switch may be configured to cause the rotating portion to start rotating when the switch is in an ON position and cause the rotating portion to stop rotating when the switch is in an OFF position. Optionally, the user-actuatable switch may be configured to or control the rotation speed of the rotating portion from 0 to 60 revolutions per minute. Optionally, the light source may comprise one or more LEDs. Optionally, the light source may comprise at least a first LED of a first color and at least a second LED of a second color. Optionally, the light source may be configured to provide changing colors of light.

Additional features and advantages of the present disclosure will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF SEVERAL VIEWS OF THE DRAWINGS

The following is a description of the examples depicted in the accompanying drawings. The figures are not necessarily to scale, and certain features and certain views of the figures may be shown exaggerated in scale or in schematic in the interest of clarity or conciseness.

FIG. 1 is a structural diagram of a path light, referred to as embodiment A.

FIG. 2 is a structural diagram of a spot path light, referred to as embodiment B.

FIG. 3 is a structural diagram of a bulb path light, referred to as embodiment C.

### THE FOLLOWING REFERENCE CHARACTERS ARE USED IN THIS SPECIFICATION

1 Securing portion
2 Extension portion
3 Globe
4 Refractive portion
5 Eave
6 Covering portion
7 Photovoltaic cell
8 Light source
9 Rotating portion
10 Reflecting portion
11 Globe tray

The foregoing summary, as well as the following detailed description of certain inventive techniques, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, specific details may be set forth in order to provide a thorough understanding of embodiments of the present invention. However, it will be clear to one skilled in the art when embodiments of the present invention may be practiced without some or all of these specific details. In other instances, well-known features or processes may not be described in detail so as not to unnecessarily obscure the invention. In addition, like or identical reference numerals may be used to identify common or similar elements.

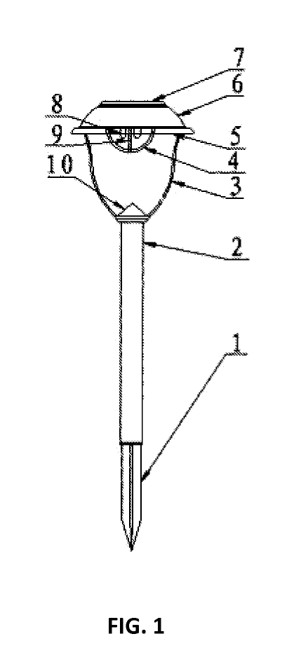

FIG. 1 illustrates a structural diagram of an embodiment of a path light of the present disclosure (for reference, identified as embodiment A), which may comprise: a light source 8 (e.g., one or more light-emitting diodes (LEDs)); a photovoltaic cell 7 (e.g., one or more photovoltaic cells); a rotating portion 9 (e.g., a rotating shaft); a refractive portion 4; a globe 3; an extension portion 2 (e.g., a rod); and a securing portion 1 (e.g., one or more stakes). The photovoltaic cell 7 may comprise a light-receiving face. The light source 8 may be configured to provide changing colors of light. For example, the light source may comprise at least a first LED of a first color and at least a second LED of a second color. The light source 8 and the photovoltaic cell 7 may be electrically connected as part of an electric circuit. The electric circuit may further comprise an electrochemical cell (e.g., a battery) and a motor (e.g., a DC motor). The photovoltaic cell 7 may be used to recharge the electrochemical cell. The electrochemical cell (and/or the photovoltaic cell 7) may be used to power both the light source 8 and the motor. The rotating portion 9 may be mechanically connected to the refractive portion 4. The rotating portion 9 may extend downwardly from the motor and may be in mechanical communication with the motor. The rotating portion 9 may be configured to rotate when the motor receives electrical energy. The rotating portion 9 may be configured to rotate at between 0.5 and 60 revolutions per minute—for example, at one (1) revolution per minute.

In embodiment A, the refractive portion 4 may at least partially extend around the exterior of the light source 8. Exterior to the refractive portion 4 may be a globe 3, which may be connected to the securing portion 1 via the extension portion 2. The term “globe” in the context of the present disclosure can refer to lamp glass or a lampshade exterior to the light source 3; “globe” does not necessarily refer to a particular shape or material. The globe may be translucent. The rotating portion 9 may be mechanically connected to the motor (e.g., a DC motor). The motor may be located internally (inside the path light) or external (outside of the path light). Inside the globe 3 may be a reflecting portion 10. On top of the globe 3 may be a covering portion 6. Extending laterally from the covering portion 6 may be an eave 5. The globe 3 may be an external lampshade. A light-receiving side of the photovoltaic cell 7 may be mounted such that it faces upwardly from the top of the covering portion 6 (e.g., on top of the covering portion 6).

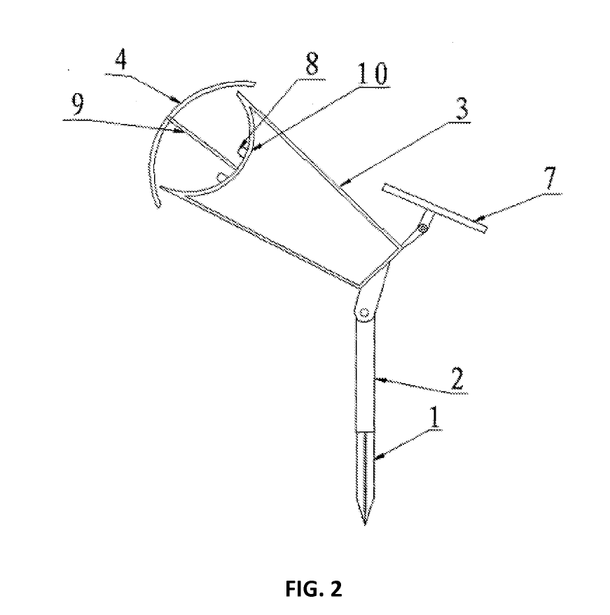

FIG. 2 illustrates a structural diagram of an embodiment of a path light of the present disclosure (for reference, identified as embodiment B), which may comprise: a light source 8; a photovoltaic cell 7; a rotating portion 9; a refractive portion 4; a globe 3; an extension portion 2; and a securing portion 1. The photovoltaic cell 7 may comprise a light-receiving face. The light source 8 may be configured to provide changing colors of light. The light source 8 and the photovoltaic cell 7 may be electrically connected as part of an electric circuit. The electric circuit may further comprise an electrochemical cell and a motor. The photovoltaic cell 7 may be used to recharge the electrochemical cell. The electrochemical cell (and/or the photovoltaic cell 7) may be used to power both the light source 8 and the motor. The rotating portion 9 may be mechanically connected to the refractive portion 4. The rotating portion 9 may extend downwardly from the motor and may be in mechanical communication with the motor. The rotating portion 9 may be configured to rotate when the motor receives electrical energy. The rotating portion 9 may be configured to rotate at between 0.5 and 60 revolutions per Minute—for example, at one (1) revolution per minute. The refractive portion 4 may at least partially extend around the exterior of the light source 8. Exterior to the refractive portion 4 may be a globe 3, which may be connected to the securing portion 1 via the connecting portion 2. The rotating portion 9 may be mechanically connected to the motor. The motor may be located internally (inside the path light) or external (outside the path light). Inside the globe 3 may be a reflecting portion 10. The globe 3 may be an external lampshade. The photovoltaic cell 7 may be mounted separate from the globe 3.

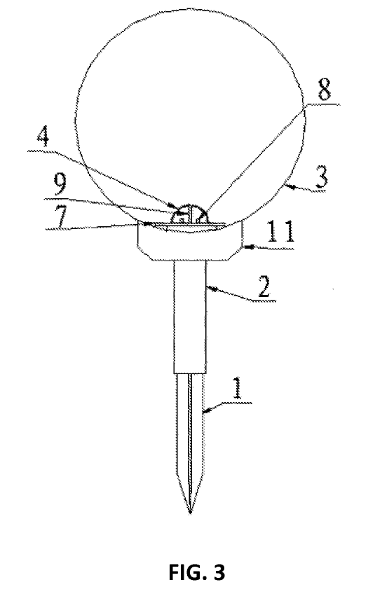

FIG. 3 illustrates a structural diagram of a path light of the present disclosure (for reference, identified as embodiment C), which may comprise a light source 8; a photovoltaic cell 7; a rotating portion 9; a refractive portion 4; a globe 3; an extension portion 2; and a securing portion 1. The photovoltaic cell 7 may comprise a light-receiving face. The light source 8 may be configured to provide changing colors of light. The light source 8 and the photovoltaic cell 7 may be electrically connected as part of an electric circuit. The electric circuit may further comprise an electrochemical cell and a motor. The photovoltaic cell 7 may be used to recharge the electrochemical cell. The electrochemical cell may be used to power both the light source 8 and the motor. The rotating portion 9 may be mechanically connected to the refractive portion 4. The rotating portion 9 may extend downwardly from the motor and may be in mechanical communication with the motor. The rotating portion 9 may be configured to rotate when the motor receives electrical energy. The rotating portion 9 may be configured to rotate at between 0.5 and 60 revolutions per minute—for example, at one (1) revolution per minute. The refractive portion 4 may at least partially extend around the exterior of the light source 8. Exterior to the refractive portion 4 may be a globe 3, which may be connected to securing portion 1 via extension portion 2. The rotating portion 9 may be mechanically connected to the motor. The motor may be located internally (inside the path light) or external (outside the path light). Inside the globe 3 may be a reflecting portion 10. The globe 3 may be an external lampshade. In between the globe 3 and the extension portion 2 may be a globe tray 11. The globe 3 may be substantially spherical or pear-shaped. The photovoltaic cell 7 may be mounted within the globe 3.

The path light of the present disclosure may also include other features, including but not limited to: a circuit board, a switch, wiring, and screws, none of which are illustrated in the drawings. The switch may be any user-actuatable switch, such as a momentary-contact switch, a rotary switch, a toggle switch, a multi-position switch, or a variable control (e.g., a variable resistor). The switch may be configured to start or stop the rotation of the rotating portion or control the speed of the rotating portion. To achieve this, the switch may cause the amount of current flowing through the motor to change. For example, the switch can directly open or close a circuit including the electrochemical cell and the motor to cause the motor to stop and start. The switch can also indirectly cause the circuit to open or close (for example, the switch could be connected to an input of a processor, which would in turn control the operation of the circuit). The switch (either directly or indirectly) may cause the amount of current flowing through the motor from the electrochemical cell to vary more gradually (rather than just ON or OFF). For example, the switch may be configured to control the rotation speed of the rotating portion from 0 to 60 revolutions per minute.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A path light comprising:
a photovoltaic cell comprising a light-receiving face;
an electrochemical cell electrically connected to the photovoltaic cell, and configured to receive electrical energy from the photovoltaic cell;
a light source electrically connected to the electrochemical cell, and configured to receive electrical energy from the electrochemical cell;
a motor electrically connected to the electrochemical cell, and configured to receive electrical energy from the electrochemical cell;
a rotating portion extending downwardly from the motor and in mechanical communication with the motor, and configured to rotate when the motor receives electrical energy;
a refractive portion in mechanical communication with the rotating portion, and configured to rotate in response to rotation of the rotating portion;
a securing portion configured to secure the path light to a bottom surface;
a covering portion above the light source, wherein the covering portion is configured to prevent at least a portion of light emitted from the light source from emanating upwardly.

2. The path light of claim 1, further comprising a globe at least partially surrounding the refractive portion.

3. The path light of claim 2, wherein the covering portion comprises an eave that extends laterally from the globe.

4. The path light of claim 2, wherein the globe is translucent.

5. The path light of claim 2, further comprising an extension portion in mechanical communication with the securing portion and the globe such that the globe is positioned above the securing portion.

6. The path light of claim 1, further comprising a reflecting portion.

7. The path light of claim 1, wherein the light-receiving face of the photovoltaic cell is positioned to face upwardly from the covering portion.

8. The path light of claim 2, further comprising a globe tray, wherein the globe tray is located between the globe and the extension portion.

9. The path light of claim 8, wherein the globe comprises an external lampshade.

10. The path light of claim 2, wherein the globe is substantially spherical.

11. The path light of claim 2, wherein the globe is substantially pear-shaped.

12. The path light of claim 1, wherein the refracting portion is bowl-shaped.

13. The path light of claim 1, wherein the motor is a DC motor.

14. The path light of claim 1, wherein the rotating portion is configured to rotate at between 0.5 and 60 revolutions per minute.

15. The path light of claim 14, wherein the rotating portion is configured to rotate at 1 revolution per minute.

16. The path light of claim 1, further comprising a user-actuatable switch, wherein the user-actuatable switch is configured to cause the rotating portion to start rotating when the switch is in an ON position and cause the rotating portion to stop rotating when the switch is in an OFF position.

17. The path light of claim 1, further comprising a user-actuatable switch, wherein the user-actuatable switch is configured to control the rotation speed of the rotating portion from 0 to 60 revolutions per minute.

18. The path light of claim 1, wherein the light source comprises one or more LEDs.

19. The path light of claim 18, wherein the light source comprises at least a first LED of a first color and at least a second LED of a second color.

20. The path light of claim 19, wherein the light source is configured to provide changing colors of light.
